(19) United States
(12) Patent Application Publication
(10) Pub. No.: US 2019/0065706 A1
(43) Pub. Date: Feb. 28, 2019

(54) MANAGEMENT APPARATUS, CONTROL METHOD, AND STORAGE MEDIUM

(71) Applicant: CANON KABUSHIKI KAISHA, Tokyo (JP)

(72) Inventor: Satoshi Nishikawa, Yokohama-shi (JP)

(21) Appl. No.: 16/107,064

(22) Filed: Aug. 21, 2018

(30) Foreign Application Priority Data
Aug. 29, 2017 (JP) 2017-164716

(51) Int. Cl. G06F 21/10; G06F 3/12

(52) U.S. Cl. CPC G06F 21/105; G06F 2221/0773; G06F 3/123

(57) ABSTRACT

When an installation task for a second application in an image forming apparatus is prepared, a management apparatus displays a warning indicating that an installation license will not be updated in an image forming apparatus when the image forming apparatus has failed to communicate with a license management system in accordance with an instruction, and prepares the installation task for delivering the second application and an update license or the update license when the image forming apparatus has succeeded in communicating with the license management system in accordance with the instruction.

### BACKGROUND OF THE INVENTION

### Field of the Invention

The present invention relates to a management apparatus, a control method, and a storage medium.

### Description of the Related Art

In the related art, a device management system and a management apparatus that acquire and manage data such as operation information of image forming apparatuses such as printers or multifunction machines are known. In view of an increase in the number of image forming apparatuses to be managed and decrease in cost and amount of maintenance of a management server, there is demand for an increase in the number of image forming apparatuses that can be managed by one management apparatus. In such a device management system, the management apparatus transmits an application and a license required for use of the application or only the license to an image forming apparatus and the image forming apparatus performs an installation process.

Japanese Patent Laid-Open No. 2009-163480 discloses that it is determined whether there is a license of which a term of validity is less than a predetermined period in an environment in which the number of apparatuses using each license is correlated with the number of valid licenses. Japanese Patent Laid-Open No. 2009-163480 also discloses that when some licenses become unavailable, the validity of a license is maintained for an apparatus which is set as a candidate in which the license is enabled in advance by a user.

However, in Japanese Patent Laid-Open No. 2009-163480, only licenses in which a fixed term of validity is set are considered for a type of license to be delivered. When a type of license to be delivered or the like is not taken into account for delivery of a license or a license and an application, the management apparatus side may not be able to appropriately perform setting or control of delivery and a delivery operation assumed by a manager may not be realized.

### SUMMARY OF THE INVENTION

The invention provides a management apparatus that can appropriately control management and delivery of an application and a license for the application.

A management apparatus according to an embodiment of the invention includes: a transmission unit that transmits an instruction causing an image forming apparatus to communicate with a license management system to the image forming apparatus when setting of delivery of an application and an update license for the application or the update license to the image forming apparatus is performed; a display unit that displays a warning indicating that a license to be delivered to the image forming apparatus will not be updated when the image forming apparatus has failed to communicate with the license management system in accordance with the instruction; and a delivery unit that delivers the application and the update license or the update license on the basis of the setting of delivery when the image forming apparatus has succeeded in communicating with the license management system in accordance with the instruction.

Further features of the present invention will become apparent from the following description of exemplary embodiments (with reference to the attached drawings).

### BRIEF DESCRIPTION OF THE DRAWINGS

FIG. 1 is a diagram illustrating a system configuration of a device management system;

FIG. 2 is a diagram illustrating an example of a hardware configuration of a management server;

FIG. 3 is a diagram illustrating a software configuration of the management server;

FIG. 4 is a diagram illustrating a software configuration of an image forming apparatus;

FIG. 5 is a configuration illustrating an example of a configuration of an application file;

FIGS. 6A to 6C are diagrams illustrating an example of a configuration of a license file and features of various licenses;

FIG. 7 is a diagram illustrating an example of an operating sequence of a second application;

FIG. 8 is a diagram illustrating a process routine of preparing an installation task of a second application;

FIG. 9 is a diagram illustrating a process routine of preparing an installation task of a second application;

FIG. 10 is a diagram illustrating a process routine of preparing an installation task of a second application;

FIG. 11 is a diagram illustrating an operating sequence before an installation task is prepared;

FIG. 12 is a diagram illustrating an operating sequence before an installation task is prepared;

FIG. 13 is a diagram illustrating an operating sequence before an installation task is prepared;

FIGS. 14A and 14B are diagrams illustrating an example of details of an update license and usage information;

FIGS. 15A to 15C are diagrams illustrating display of a warning;

FIG. 16 is a diagram illustrating a process routine of preparing an installation task of a second application;

FIG. 17 is a diagram illustrating a process routine of preparing an installation task of a second application;

FIG. 18 is a diagram illustrating a sequence of preparing and executing an installation task;

FIG. 19 is a diagram illustrating display of a warning; and

FIG. 20 is a diagram illustrating a process routine of executing an installation task of a second application.

### DESCRIPTION OF THE EMBODIMENTS

Hereinafter, embodiments of the invention will be described with reference to the accompanying drawings or the like.

### First Embodiment

<Description of System Configuration>

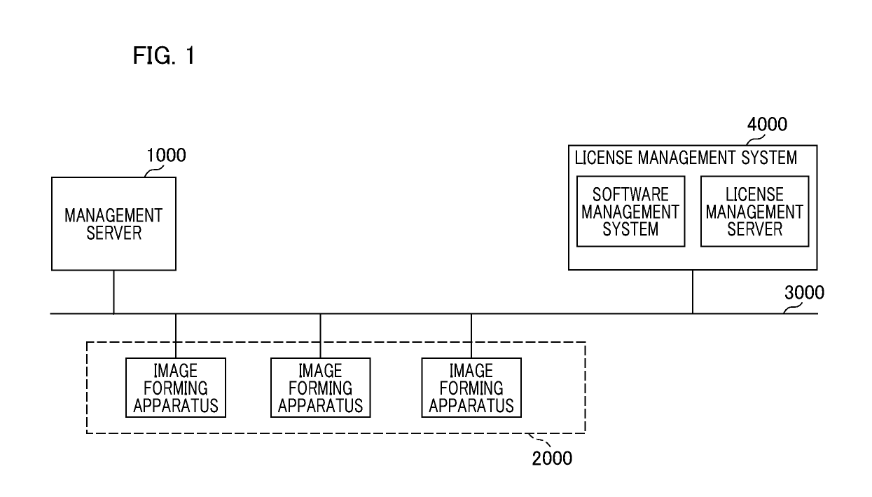

FIG. 1 is a diagram illustrating an example of a system configuration of a device management system according to an embodiment of the invention.

In FIG. 1, a device management system includes a management server 1000, one or more image forming apparatuses 2000, and a license management system 4000. The management server 1000, the image forming apparatuses 2000, and the license management system 4000 are communicatively connected to each other via a network 3000 based on Ethernet (registered trademark) or the like.

Each image forming apparatus 2000 receives print data from a client computer (not illustrated) via the network 3000 and performs printing on an actual sheet of paper using printing technology such as electrophotography technology or ink jet technology. The image forming apparatus 2000 has a function of reading a paper original via a scanner and copying the read paper original or converting the read paper original into image data and transmitting the image data by e-mail or the like. An image forming apparatus 2000 not having a copying function or an image forming apparatus 2000 not having a scanner function can be used. The image forming apparatus 2000 can have a function added thereto by installing an application. Examples of the image forming apparatus include a printer and a multifunction machine.

The management server 1000 collects and manages a variety of data from the image forming apparatuses 2000 or controls management and delivery of an application for the image forming apparatuses 2000 and a license of the application. The license management system 4000 is a system that manages various licenses required for installing an application in the image forming apparatuses 2000 and enabling the application. The license management system 4000 includes a license management server and a software management system.

It is assumed that each image forming apparatus 2000 communicates with the software management system of the license management system 4000 via a LAN, the Internet, and the like. Communication between the image forming apparatus 2000 and the license management system 4000 may be performed without passing through the software management system, that is, the image forming apparatus 2000 may directly communicate with the license management server. In this case, the license management system 4000 may include only the license management server.

<Hardware Configuration of Management Server>

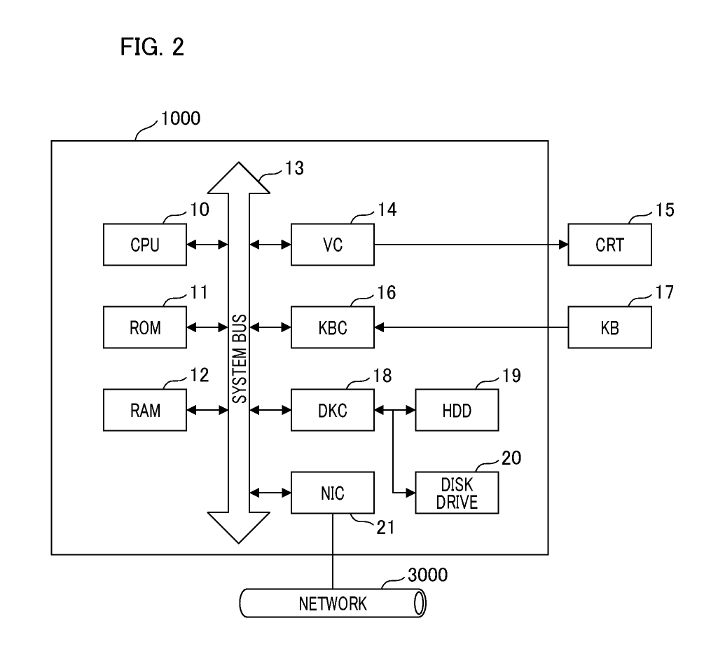

FIG. 2 is a diagram illustrating an example of a hardware configuration of the management server 1000.

The management server 1000 includes a CPU 10 that executes various programs such as an OS, firmware, an application program, and device management software which will be described later and which are stored in a ROM 11 or a HDD 19. The CPU 10 collectively controls hardware connected to a system bus 13.

More specifically, the CPU 10 realizes functions of a device managing unit 30 of the management server 1000 by executing programs stored in the ROM 11 and the HDD 19. Functions (a software configuration) of the management server 1000 and processes of flowcharts which will be described later are realized by the device managing unit 30.

The programs causing the CPU 10 to realize the device managing unit 30 are supplied, for example, by a storage medium such as a flexible disk (FD), a CD-ROM, a DVD, a magnetic tape, or an IC memory card which can be mounted on a disk drive 20. Here, the disk drive 20 and the HDD 19 are connected to the system bus 13 via a disk controller (DKC) 18. A RAM 12 serves as a main memory and a work area of the CPU 10.

The CPU 10 displays a user interface on a display device (CRT) 15 via a video card (VC) 14. The CPU 10 performs control based on an input instruction to the user interface which is received from a keyboard (KB) 17 via a keyboard controller (KBC) 16 or a pointing device such as a mouse. The CPU 10 performs data communication with the image forming apparatuses 2000 and the license management system 4000 in the network 3000 via a network interface board (NIC) 21.

<Software Configuration of Management Server>

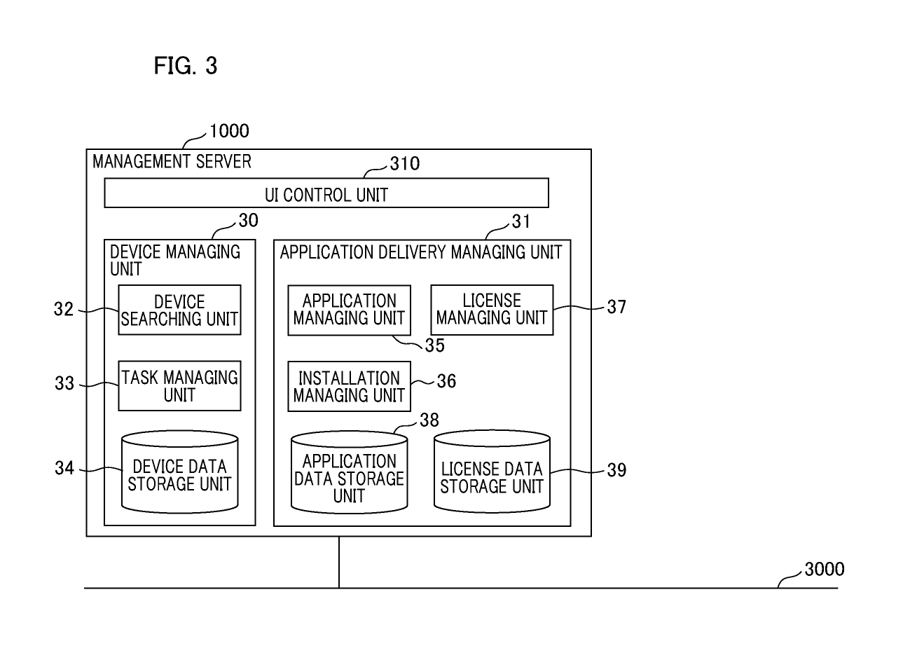

FIG. 3 is a diagram illustrating a configuration of device management software that operates in the management server 1000.

In FIG. 3, the management server 1000 includes a device managing unit 30, an application delivery managing unit 31, and a UI control unit 310.

Various software modules illustrated in FIG. 3 serve as entities for processing of device management software which will be described later. The UI control unit 310 provides a graphical user interface for allowing a manager of an image forming apparatus 2000 to operate the software. The graphical user interface is configured to be displayed on a display device 15 of the management server 1000. Alternatively, the graphical user interface may be configured as a web application which can be used via a web browser by another client PC using Hyper Text Transfer Protocol (HTTP).

The device managing unit 30 includes a device searching unit 32, a task managing unit 33, and a device data storage unit 34. The device searching unit 32 prepares a task for detecting the image forming apparatuses 2000 connected to the network 3000 and stores the task in the device data storage unit 34. The device searching unit 32 controls execution of the prepared task. The device searching unit 32 searches the image forming apparatuses 2000 connected to the network 3000 using techniques such as SNMP, IP broadcast, or SLP/Multicast.

The device searching unit 32 searches the image forming apparatuses 2000 at an arbitrary time. In this embodiment, the device searching unit 32 acquires device information such as device names, product names, and IP addresses as a result of device searching and stores the device information in the device data storage unit 34. The device searching unit 32 has a function of acquiring/changing a variety of information of the image forming apparatuses 2000 using techniques such as management information base (MIB) via the network 3000.

The task managing unit 33 has a function of executing the task which is prepared by the device searching unit 32 or an installation managing unit 36 and stored in the device data storage unit 34. A function of causing the management server 1000 to execute the task and execution conditions such as execution times (a schedule) are set in the task. The task managing unit 33 instructs the device searching unit 32 having stored the task or the installation managing unit 36 to execute the task in accordance with the schedule set in the task.

The device data storage unit 34 is a data storage medium such as a database that operates in the HDD 19 and stores table data such as a device list. Information of devices which are managed by the management server 1000 is stored in the device list. Information of devices is information such as identification information (serial numbers) of devices, devices names, address information (IP addresses), and a firmware version of devices, and installation places.

The application delivery managing unit 31 includes an application managing unit 35, an installation managing unit 36, a license managing unit 37, an application data storage unit 38, and a license data storage unit 39. The application managing unit 35 manages information of an application file which will be described later. An application file is configured as one file into which a plurality of files are compressed such as a CAB file, a JAR (Java (registered trademark) ARchive) file, or a ZIP file.

The application managing unit 35 receives an application file from the UI control unit 310, decompresses the application file, and then extracts a manifest file therefrom. Then, the application managing unit 35 construes the manifest file and extracts application attachment information such as an application name, an application ID, and a version. Thereafter, the application managing unit 35 stores the application attachment information along with the application file in the application data storage unit 38.

The installation managing unit 36 receives an installation instruction from the UI control unit 310, connects to an image forming apparatus 2000, and prepares (registers) a task for requesting the image forming apparatus 2000 to install an application. The license managing unit 37 manages information on a license registered via the UI control unit 310. The license managing unit 37 extracts information such as an application ID or a serial number of the image forming apparatus as an installation destination from the registered license and stores the information along with the license in the license data storage unit 39.

<Software Configuration of Image Forming Apparatus>

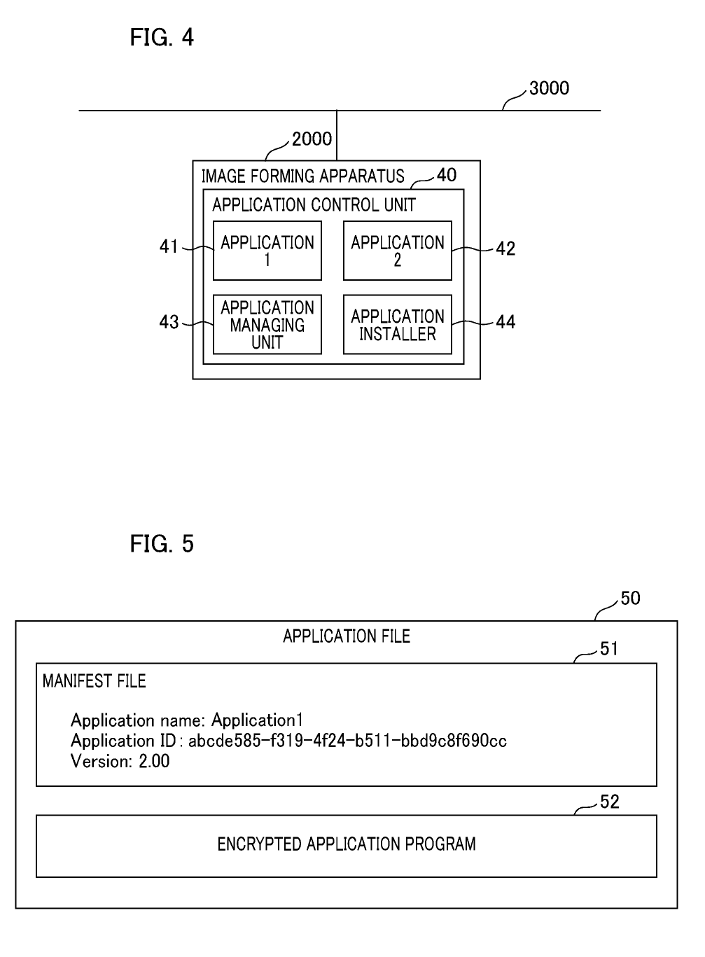

FIG. 4 is a diagram illustrating a software configuration of an application control unit 40 that operates in an image forming apparatus 2000.

The application control unit 40 performs control such as start/stop/installation/update/uninstallation of an application that operates in the image forming apparatus 2000. The application control unit 40 includes an application managing unit 43 and an application installer 44. The application managing unit 43 is a software module that manages a plurality of application groups that can be dynamically installed.

Applications 41 and 42 are application programs (hereinafter referred to as applications) that operate under the control of the application managing unit 43 and realize various functions of the image forming apparatus 2000. The applications 41 and 42 provide a user with various functions in cooperation with the image forming apparatus 2000. That is, the application managing unit 43 causes applications for providing various services of the image forming apparatus 2000 to operate.

Applications include applications of which a license required for enabling the corresponding applications is managed and applications of which a license is not managed or not required. The applications of which a license is managed are classified into two types depending on the type of the license. One is an application which is enabled by a license with a fixed term of validity and which is referred to as a first application. An application of which a license has an indefinite term of validity is included in the first application.

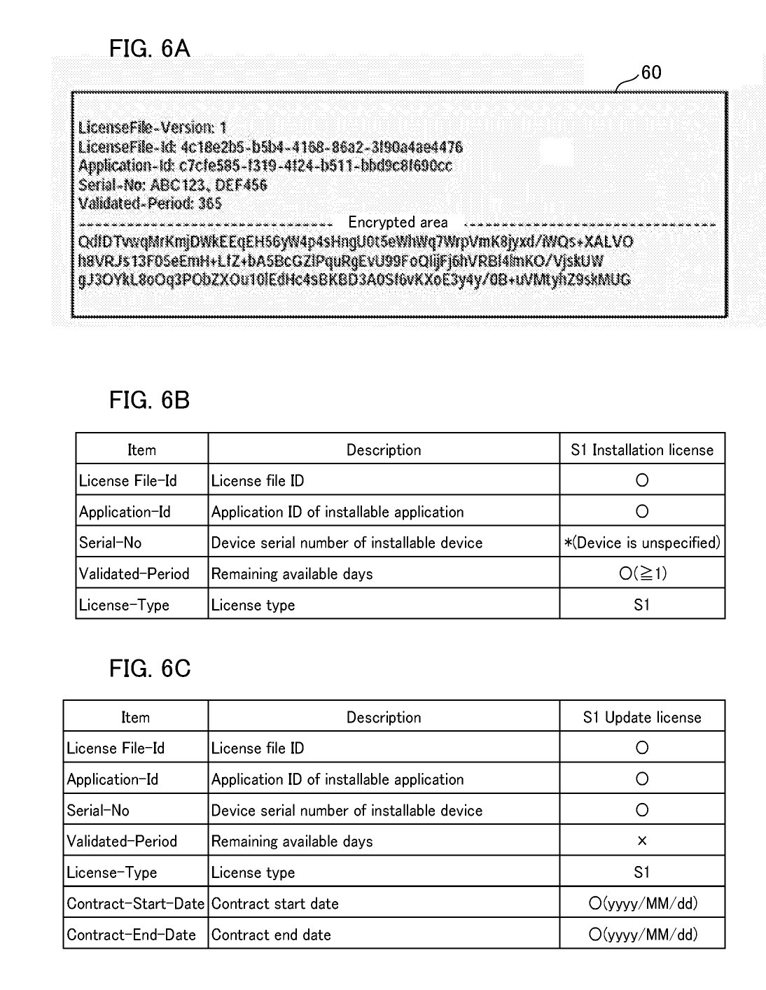

The other is an application which is continuously enabled by a license of which the term of validity is updated by communicating with an external system, for example, the license management system 4000 in this embodiment and which is referred to as a second application. The licenses that enable the second applications include an installation license and an update license. These will be described in detail with reference to FIGS. 6A to 6C. In the external system, image forming apparatuses serving as an installation destination of the second application, various applications, and licenses for the various applications are managed.

Examples of the applications 41 and 42 include an application for processing and compressing an image, an application for performing department management such as printing restriction, and a plug-in module that is installed as a part of an application. Examples of the applications 41 and 42 include an application for remotely managing an image forming apparatus 2000 and an application for controlling a unit such as a finisher of an image forming apparatus 2000 such that bookbinding is performed.

Examples of the applications 41 and 42 include an application for converting and analyzing specific document data. Examples of the applications 41 and 42 include a document preparing program such as so-called word processor software, a schedule managing program, a spreadsheet program, and a database managing program. Examples of the applications 41 and 42 include a server program for realizing a printing service via the Internet.

The application installer 44 installs an application in an image forming apparatus 2000, and the application managing unit 43 adds the applications 41 and 42 to management objects in response to installation of the application. The application installer 44 deletes an application from the image forming apparatus 2000, and the application managing unit 43 excludes the applications 41 and 42 from the management objects in response to deletion of the application.

<Configuration of Application File>

FIG. 5 is a diagram illustrating an example of a configuration of an application file that is delivered from the management server 1000.

An application file is a file including a file of an application program (which may be compressed) and a meta data file thereof.

In FIG. 5, an application file 50 is configured as one file into which a plurality of files are compressed such as a CAB file, a JAR (Java (registered trademark) ARchive) file, or a ZIP file. The application file 50 includes a manifest file 51 and an application program 52.

Application attachment information such as an application name, an application ID for uniquely identifying the application, and a version is described in the manifest file 51. The application program 52 in the application file 50 is encrypted to prevent falsification of the program by a third party or the like. The application file 50 is distributed to users via a storage medium such as a CD or media such as the Internet.

<Configuration of License File>

FIG. 6A is a diagram illustrating an example of a configuration of a license file that is delivered from the management server 1000.

An application ID (Application-Id) of the application that is enabled by the corresponding license is described in the license file 60. The application ID is an identifier for uniquely identifying the application.

Information such as a serial number (Serial-No) of the image forming apparatus 2000 in which installation of the application is permitted and a term of validity (Validated-Period) is described in the license file 60. In the license file 60, information such as a license key is encrypted and stored in the license file in order to prevent falsification of the license file by a third party.

For example, a user of a first application sends a serial number of the image forming apparatus 2000 in which the application is used and a license certificate number (ID) included in a package of an application to a license issuer. The license issuer prepares a license file 60 from the serial number and the license certificate number (ID) and distributes the license file to the application user via a storage medium such as a CD or a medium such as the Internet.

FIGS. 6B and 6C are diagrams illustrating features of the license for the second application.

The license for the second application includes an installation license and an update license. The installation license is a license for installing the second application which is used at the time of installation. FIG. 6B illustrates features of the installation license.

A device (an image forming apparatus in this embodiment) which is an object of the installation license is unspecified. That is, a specific device is not described using Serial-No in the license file. A remaining term of validity is set to be fixed as a period (a term of validity) in which the second application is enabled by the installation license.

For example, the number of remaining available days may be set as Validated-Period in the license file. Even when the term of validity has expired, the license file can be used to install the second application. Even when an application is installed by a license of which the term of validity has expired, the application is not enabled and thus usage thereof cannot be started.

The update license is periodically acquired from an external system by a device in which the second application has been installed. By allowing the device to enable (start usage) the second application using the update license, the device can continue to use the second application. FIG. 6C illustrates features of the update license.

A device which is an object of the update license is set to be fixed. For example, a specific device is described as Serial-No in the license file. A start time and an end time of an enabled period are set to be fixed as a period (a term of validity) in which the second application is enabled by the update license.

For example, in the license file, a contract start date of the second application is described as Contract-Start-Date and a contract end date of the second application is described as Contract-End-Date. In a device which is an object of an update license, the update license may also be used to install the second application.

<Operating Sequence of Second Application>

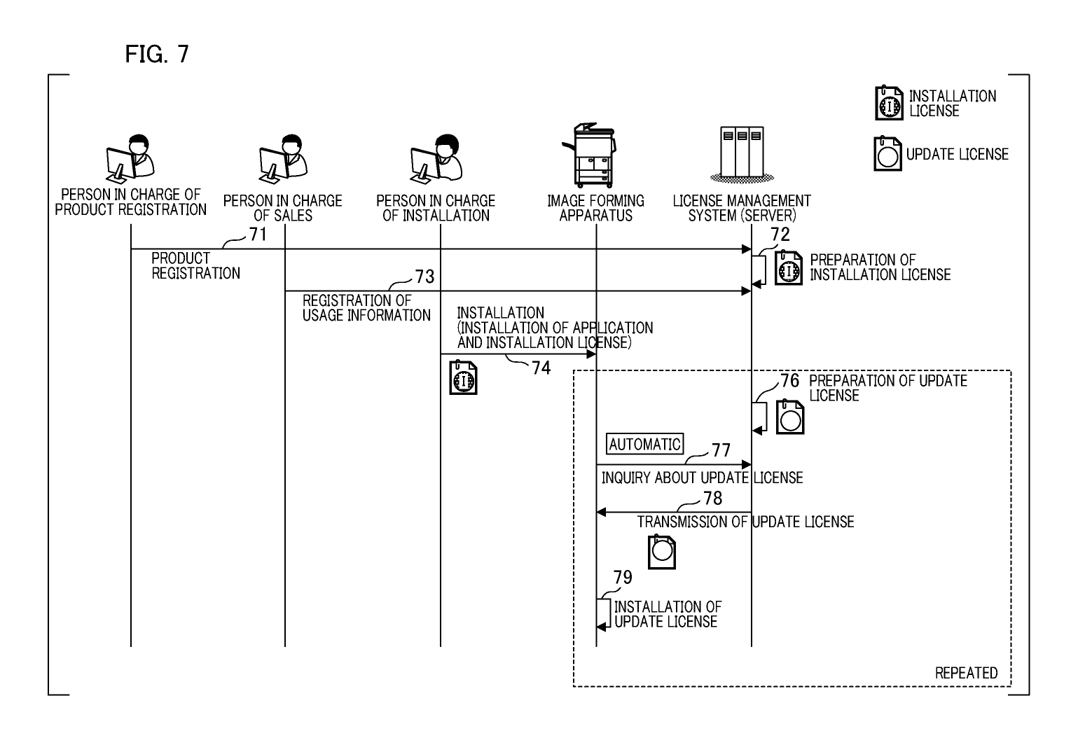

FIG. 7 is a diagram illustrating an example of an operating sequence of a second application.

First, a person in charge of product registration performs product registration (71) of a second application to be sold in the license management server of the license management system 4000. At this time, the second application as a product type and a term of validity after being installed are set. When the product registration (71) of the second application is received, the license management server performs preparation (issuance) (72) and registration (73) of an installation license for the application.

A person in charge of sales performs registration (73) of usage information in the license management server. The usage information includes information such as a serial number of an image forming apparatus which utilizes the second application and a term of validity of the second application. An update license is issued by performing registration of usage information, and the image forming apparatus can continuously use the second application by acquiring the update license.

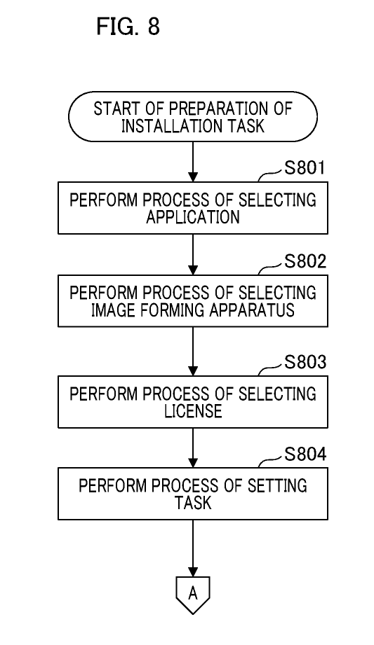

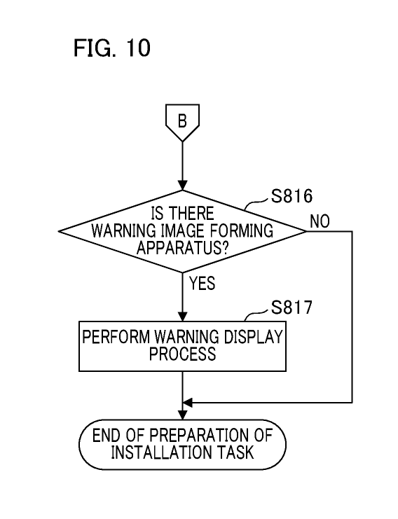

A person in charge of installation performs installation work (74) on the image forming apparatus using the second application and the installation license. Specifically, the second application is installed along with the installation license. As will be described later, the person in charge of installation can install an application in the image forming apparatus even when installation work (74) is not directly performed on the image forming apparatus by preparing (registering) an installation task in the management server 1000. Details of the preparation of an installation task will be described later with reference to FIGS. 8 to 10.

The person in charge of installation performs the installation work (74) using an installation screen displayed on the image forming apparatus or the device management system. The installation work (74) may be performed before the usage information registration (73). That is, the order in which the installation work (74) and the usage information registration (73) are performed is not particularly limited. Even when the usage information registration (73) is not performed, the second application can be used by the installation work (74) until the term of validity indicated by the installation license expires.

When the usage information registration (73) is performed, the license management server performs preparation of an update license (76). In the update license, the serial number of the image forming apparatus which is an object of the update license and the term of validity of the second application based on the update license are set as illustrated in FIG. 6C. In this embodiment, a contract start date and a contract end date of the second application are set as the term of validity of the second application.

In the image forming apparatus in which the second application is installed, inquiry of an update license (77) is automatically performed at the time of restarting, at a specific time, or the like. The license management server performs the usage information registration (73) when the inquiry of an update license is received, and performs transmission of an update license (78) when the update license is prepared.

The image forming apparatus having received the update license performs installation of an update license (79). Accordingly, the image forming apparatus can use the second application in a period from the contract start date to the contract end date. Thereafter, with update of the usage information registration, the processes from preparation of an update license (76) to installation of an update license (79) are performed to extend the term of validity.

That is, the license management server issues an update license in which the term of validity of the second application changes whenever usage information is registered (updated). The image forming apparatus enables the second application using the new update license acquired from the license management server and continues to use the second application. When the term of validity of the installation license has expired or the contract end date of the update license has elapsed without performing the usage information registration (73), the application is automatically stopped by the application managing unit 43 and thus cannot be used.

FIGS. 8 to 10 are flowcharts illustrating process routines of preparing (registering) a task (an installation task) for allowing the management server 1000 to install a second application in an image forming apparatus.

The process routines illustrated in FIGS. 8 to 10 are embodied by causing the CPU 10 to load and execute device management software in the RAM 12.

The management server 1000 prepares an installation task and requests the image forming apparatus to install the second application. Before an installation task is prepared, a user registers a second application and a license for the second application in the management server 1000.

Specifically, the user registers an application on a screen which is displayed by the UI control unit 310 under the control of the application managing unit 35 of the management server 1000. The user registers a license use for the installation on a screen which is displayed by the UI control unit 310 under the control of the license managing unit 37 of the management server 1000. The registered second application and the registered license are stored in the application data storage unit 38 and the license data storage unit 39, respectively.

In this embodiment, an update license is used as a license which is used to install the second application. As described above, the second application can be installed using an update license. An installation license may be used as a license which is used to install the second application. The management server 1000 can acquire (download) the applied installation license or the applied update license from the image forming apparatus by instructing the image forming apparatus to uninstall the application.

In Step S801, the installation managing unit 36 receives selection of an application to be installed from a user via the UI control unit 310. Here, the selected application may be a first application or may be a second application. Here, a plurality of applications may be selected. For example, the user may select an application to be installed from a selection screen, which is not illustrated, displayed by the UI control unit 310.

In Step S802, the installation managing unit 36 receives selection of an image forming apparatus as an installation destination from a user via the UI control unit 310. The user selects an image forming apparatus as an installation destination from a selection screen, which is not illustrated, displayed by the UI control unit 310. The image forming apparatuses 2000 connected to the network 3000 are searched in advance by the device searching unit 32 and then the selectable image forming apparatuses are acquired from the results of searching stored in the device data storage unit 34. Here, a plurality of image forming apparatuses may be selected.

It is assumed that which of the applications selected in Step S801 should be installed in which of the image forming apparatuses selected can be designated in Step S802. The image forming apparatuses selected in Step S802 may include an image forming apparatus for which an application to be installed is not designated. That is, in an installation task, only a license selected in Step S803 which will be described later can be delivered to the image forming apparatus selected in Step S802.

In Step S803, the installation managing unit 36 receives selection of a license for an application to be installed from the user via the UI control unit 310. For example, the user may select a license for an application to be installed from a license selection screen, which is not illustrated, displayed by the UI control unit 310. An update license can be selected as the license for the second application in addition to the installation license.

In this embodiment, it is particularly assumed that an update license is selected as a license for installing the second application. It is also assumed that which of an installation license and an update license to use as a license for an application to be installed can be designated for each image forming apparatus selected in Step S802.

In Step S804, the installation managing unit 36 receives setting of a task such as a schedule for executing an installation task from a user via the UI control unit 310. For example, regarding the setting of a task, the user may set a task execution time from an input screen, which is not illustrated, displayed by the UI control unit 310. The task managing unit 33 instructs the installation managing unit 36 to execute a task on the basis of the schedule set in the task. Accordingly, the installation managing unit 36 executes the installation task.

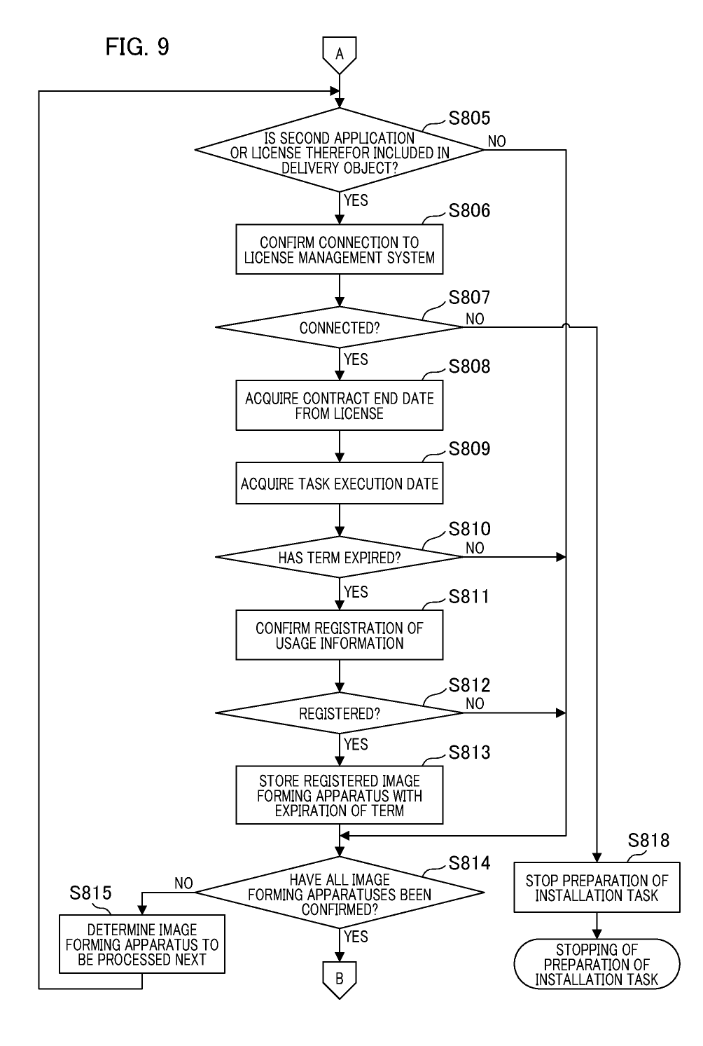

The processes of Steps S805 to S814 in FIG. 9 are repeatedly performed on all the image forming apparatuses selected in Step S802. First, in Step S805, the installation managing unit 36 determines whether a second application and an update license are included regarding the application which is installed in an image forming apparatus to be processed and a license for the application. That is, in Steps S801 and S803, the installation managing unit 36 determines whether a second application and an update license are selected as an application which is installed in an image forming apparatus to be processed.

As the installation task, an installation task for delivering only a license can also be prepared instead of delivering an application and a license for the application. In this case, in Step S805, it is determined whether an update license is included as a license which is installed in the image forming apparatus to be processed.

In the subsequent processes for the installation task for delivering only a license, a part described as “a second application license and an update license for the second application” has only to be changed to “an update license for a second application.”

When there are a second application and an update license for the second application, the process routine transitions to Step S806. When there are not a second application and an update license for the second application, the process routine transitions to Step S814. In Step S806, the installation managing unit 36 instructs an image forming apparatus to be processed to confirm whether the image forming apparatus is connected to the license management system 4000.

This is because the image forming apparatus 2000 may not be able to communicate with the license management system 4000 due to a problem in settings associated with a network environment, a problem on a software management system side, or the like. When the instruction for confirmation is received, the application managing unit 43 of the image forming apparatus confirms connection to the license management system 4000, that is, communicates with the license management system 4000, and notifies (returns) the result of confirmation of connection to the management server.

In Step S807, the installation managing unit 36 receives the result of confirmation from the image forming apparatus and determines whether the image forming apparatus is connected to the license management system 4000. The process routine transitions to Step S808 when the image forming apparatus is connected to (has succeeded in communicating with) the license management system 4000, and the process routine transitions to Step S818 when the image forming apparatus is not connected (has failed to communicate).

When a second application is installed using an update license and the image forming apparatus is not connected to the license management system 4000, the license cannot be updated and thus the installation cannot be completed. Accordingly, in this embodiment, even when there is one image forming apparatus not connected to the license management system 4000, preparation of an installation task is stopped.

However, for example, information of an image forming apparatus not connected to the license management system 4000 may be stored in the RAM 12 and may be used when a warning is displayed in a subsequent step (for example, S813). A warning indicating that a license to be delivered will not be updated may be displayed as a warning for the image forming apparatus of which the information is stored.

In Step S808, the installation managing unit 36 acquires a contract end date of an application indicated by the update license selected in Step S803. As described above, this is acquired from information which is information on the license registered in the management server 1000 by the user before the installation task is prepared and which is then extracted and stored in the license data storage unit 39 by the license managing unit 37. Specifically, the installation managing unit 36 acquires a value set in Contract-End-Date described in the license file (FIG. 6C).

In Step S809, the installation managing unit 36 acquires a schedule in which the installation task is executed. Specifically, the installation managing unit 36 acquires an execution time of the installation task on the basis of the setting of the task received in Step S804. In Step S810, the installation managing unit 36 determines whether the execution time of the installation task is within the term of validity indicated by the update license selected in Step S803.

In other words, the installation managing unit 36 determines whether the update license used for installation at the time of execution of the installation task is valid. The installation managing unit 36 determines that the update license is valid when the execution time of the installation task acquired in Step S808 is before the contract end date of the term of validity described in the update license acquired in Step S809.

When the execution time of the installation task is within the term of validity indicated by the update license, the process routine transitions to Step S814. When the execution time of the installation task is not within the term of validity indicated by the update license, the process routine transitions to Step S811. In Step S811, the installation managing unit 36 instructs the image forming apparatus to be processed to confirm whether usage information has been registered (there is registration information) in the license management system 4000.

The management server 1000 may inquire of the license management system 4000 about whether usage information has been registered. When the instruction for confirmation is received, the application managing unit 43 of the image forming apparatus inquires of the license management system 4000 about registration confirmation of the usage information and notifies the management server of the result of inquiry.

In Step S812, the installation managing unit 36 receives the result of confirmation from the image forming apparatus and determines whether usage information of the image forming apparatus has been registered in the license management system 4000. The process routine transitions to Step S813 when the usage information has been registered, and the process routine transitions to Step S818 when the usage information has not been registered.

When a second application is installed using an update license, the term of validity indicated by the license has elapsed (expired), and usage information after the term of validity has been updated has not been registered, the application cannot be enabled. When there is any image forming apparatus for which the term of validity indicated by the update license has elapsed and usage information after the term of validity has been updated has not been registered, preparation of an installation task is stopped.

However, for example, information of the image forming apparatus for which the term of validity indicated by the update license has elapsed and usage information after the term of validity has been updated has not been registered may be stored in the RAM 12 and may be used to display a warning in a subsequent step (for example, S813). Here, a warning indicating that the license to be delivered will not be updated is displayed as a warning for the image forming apparatus.

In Step S813, the installation managing unit 36 stores information of the image forming apparatus of which usage information has not been registered in the RAM 12. The stored information is used to display a warning in a subsequent step. In Step S814, the installation managing unit 36 determines whether the processes of Steps S805 to S813 have been performed on all the image forming apparatuses selected as an installation destination in Step S802.

In other words, it is determined whether confirmation of connection to the license management system 4000, confirmation of whether the update license is valid at the time of execution of the installation task, and registration confirmation of usage information have been performed on all the image forming apparatuses. When the processes of Steps S805 to S810 have been performed on all the image forming apparatuses, the process routine transitions to Step S816. When the processes of Steps S805 to S810 have not been performed on all the image forming apparatuses, the process routine transitions to Step S815.

In Step S815, the installation managing unit 36 determines a next image forming apparatus to be processed in Steps S805 to S813. Then, the process routine returns to Step S805. Thereafter, the processes of Steps S802 to S815 are repeatedly performed on all the image forming apparatuses selected as an installation destination in Step S802. That is, confirmation of connection to the license management system 4000, confirmation of whether the update license is valid at the time of execution of the installation task, and registration confirmation of usage information are performed on all the image forming apparatuses selected as an installation destination in Step S802.

In Step S816, the installation managing unit 36 determines whether there is information of the image forming apparatus stored in Step S813. That is, the installation managing unit 36 determines whether there is an image forming apparatus for which a warning is displayed. The process routine transitions to Step S817 when there is an image forming apparatus for which a warning is displayed, an installation task is prepared when there is no image forming apparatus for which a warning is displayed, and then the process routines illustrated in FIGS. 8 to 10 end.

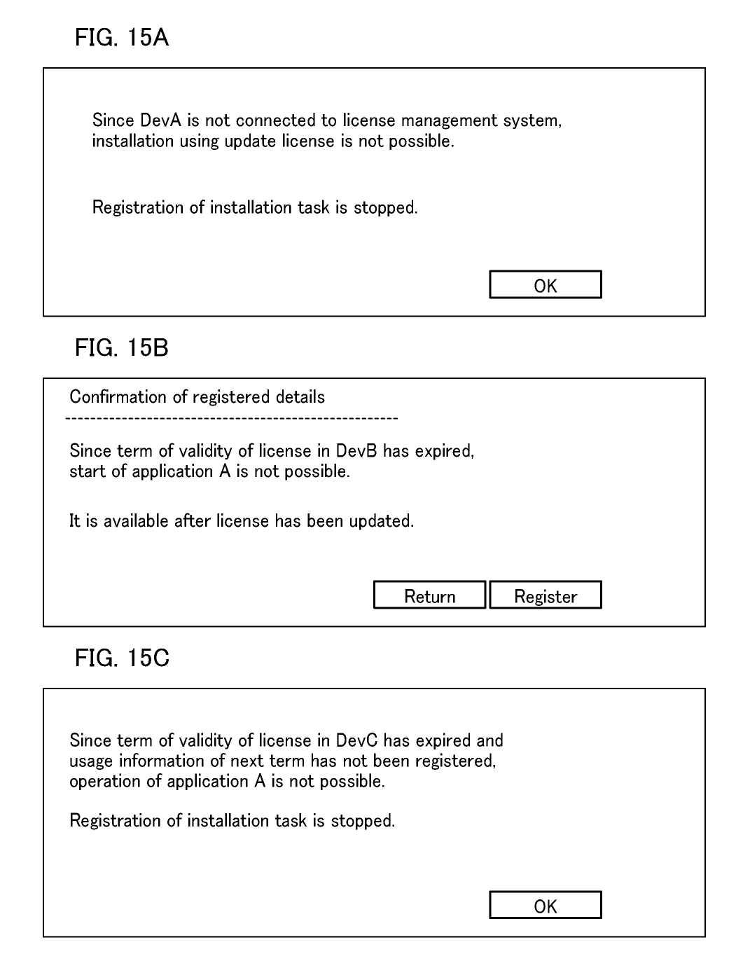

In Step S817, the installation managing unit 36 controls the UI control unit 310 such that a warning is displayed. An example of the warning is a warning indicating that the license is invalid, and thus usage of the application cannot be immediately started, but usage may be started after the license is updated. An example of the warning displayed in Step S817 will be described later with reference to FIGS. 15A to 15C.

As described above, a warning indicating that a license to be delivered will not be updated may be displayed in any one of the following cases. That is, such a case is one of a case in which an image forming apparatus as an installation destination is not connected to the license management system 4000, a case in which the term of validity indicated by an update license to be delivered has elapsed, and a case in which usage information has not been registered after the term of validity has been updated.

In Step S818, the installation managing unit 36 stops preparation of a task for installing the second application in the image forming apparatus. The installation managing unit 36 displays a message indicating that preparation of an installation task has been stopped via the UI control unit 310. An example of the display will be described later with reference to FIGS. 15A to 15C.

In this way, in this embodiment, preparation of an installation task can be stopped or a warning indicating that a license will not be updated can be displayed in the following apparatus of the image forming apparatuses in which the second application is to be installed. The following apparatus is one of a case in which an image forming apparatus as an installation destination is not connected to the license management system 4000, a case in which the term of validity indicated by an update license to be delivered has elapsed, and a case in which usage information has not been registered.

<Sequence of Preparing Installation Task of Second Application>

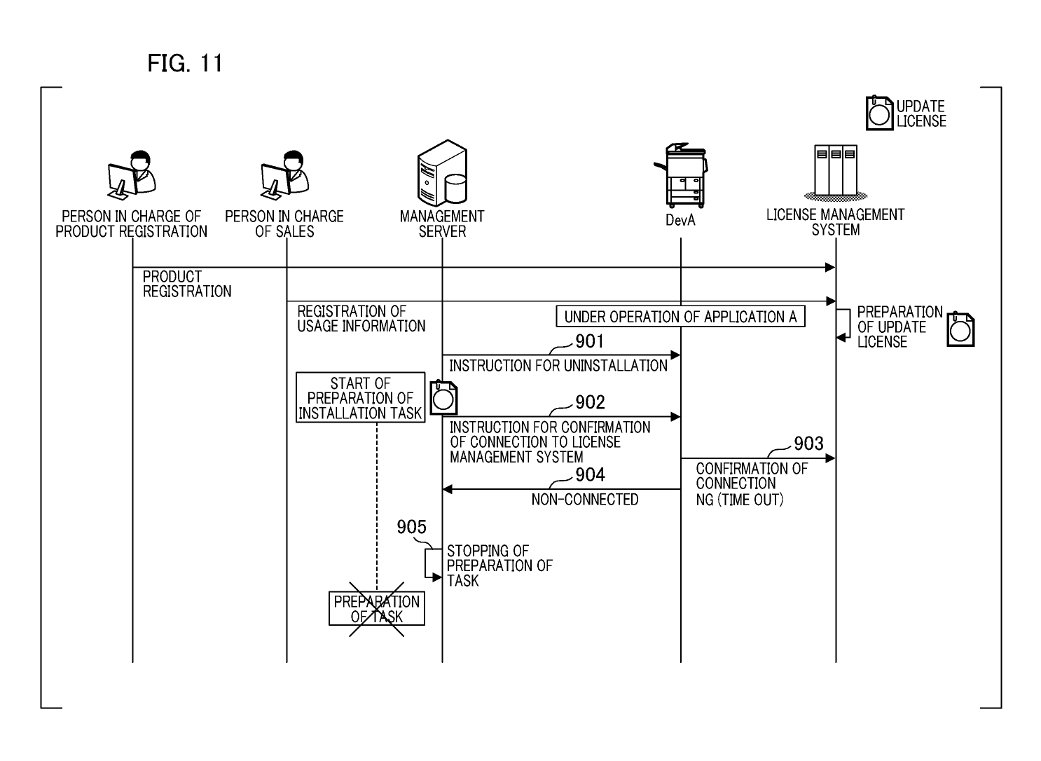

FIGS. 11 to 13 are diagrams illustrating an example of an operating sequence before an installation task of a second application is prepared.

In FIGS. 11 to 13, the processes corresponding to FIGS. 8 to 10 will be referred to by the same step numbers in the following description.

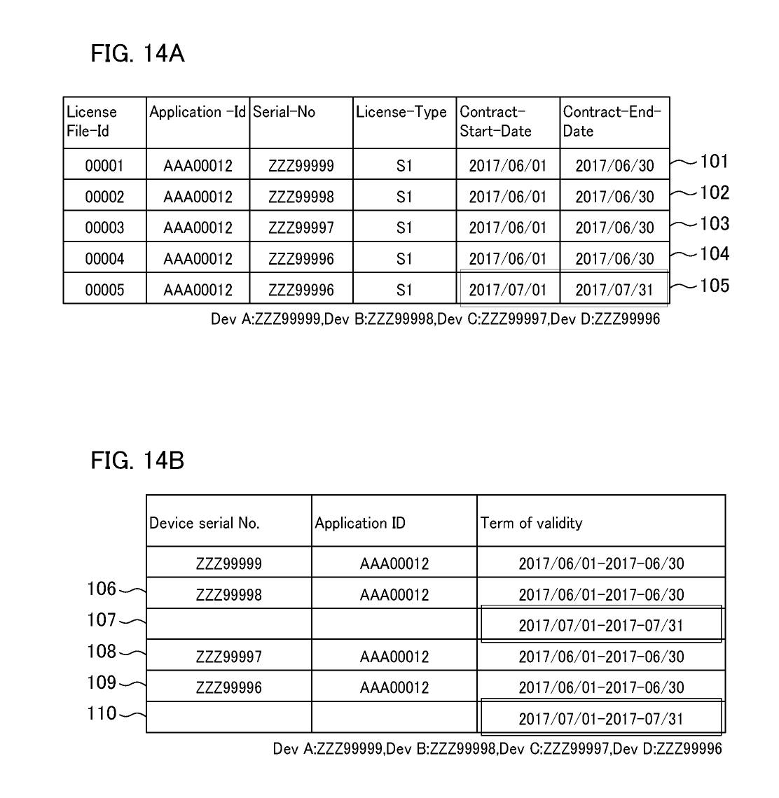

FIG. 11 is a diagram illustrating an example in which the management server 1000 prepares a task for installing a second application A in an image forming apparatus DevA. An application ID (Application-ID) of the application A is assumed to be AAA00012. Details of a license selected in the prepared installation task (S803) are illustrated in FIG. 14A.

In FIG. 14A, details of the license for the image forming apparatus DevA are assumed to designate a license 101. Specifically, the license is a license for enabling an application with an application ID (Application-ID) of AAA00012. A device (Serial-No) which is an object of the license 101 is ZZZ9999 (DevA).

The type of the license (License-Type) is S1. When it is mentioned that the type of a license is “S1,” this means that it is a license for a second application. When it is mentioned that the type of a license is “N1,” this means that it is a license for a first application.

Contract-Start-Date and Contract-End-Date are set as a term of validity, and details thereof are set to 2017 Jun. 1 and 2017 Jun. 30. That is, a start time and an end time of a period in which the application is enabled by the license 101 are set to 2017 Jun. 1 and 2017 Jun. 30.

In FIG. 11, it is assumed that product registration of the application A in the license management server of the license management system 4000 has been performed and usage information of the image forming apparatus DevA has been registered before the installation task is prepared as illustrated in FIG. 7. Accordingly, in the image forming apparatus DevA, an update license is applied and the application A is used.

Thereafter, uninstallation (901) of the application A is performed in accordance with an instruction from the management server 1000, and the applied license is extracted by the management server 1000. The extracted license is stored in the license data storage unit 39 of the management server 1000.

In FIG. 11, it is assumed that the image forming apparatus DevA is not connected to the license management system 4000, that is, they cannot communicate with each other, at a time point at which preparation of an installation task is started. An example in which the management server 1000 prepares a task for installing the second application A in the image forming apparatus DevA in this state will be described below.

In FIG. 11, when the installation task is prepared, installation of a second application is selected (S801), and an update license for the second application is selected as a license which is used for installation (S803). At this time, it is determined that there are the second application and the update license for the second application (S805), and instruction for confirmation of connection (902) to the license management system 4000 is performed on the image forming apparatus DevA (S806).

As described above, when an installation task for the image forming apparatus DevA is prepared, the second application may not be selected and only the update license for the second application may be selected.

When the instruction for confirmation of connection is received, the image forming apparatus DevA performs connection confirmation (903) to the license management system 4000. Since the image forming apparatus DevA is not connected to the license management system 4000, the image forming apparatus DevA times out and performs notification (904) indicating that the image forming apparatus DevA is not connected (non-connection) to the management server 1000. The management server 1000 performs stopping of preparation of an installation task (905) in response to the notification (S818). The management server 1000 displays a message indicating that preparation of the installation task has been stopped.

FIG. 15A illustrates an example of a screen which is displayed when an image forming apparatus as an installation destination is not connected to the license management system 4000.

The screen displays an image forming apparatus which is not connected to the license management system and thus in which an application cannot be installed using the update license. Stopping of preparation of the installation task for the application is also displayed. As described above, a warning indicating that the license to be delivered will not be updated may be displayed instead of displaying information associated with preparation of the installation task.

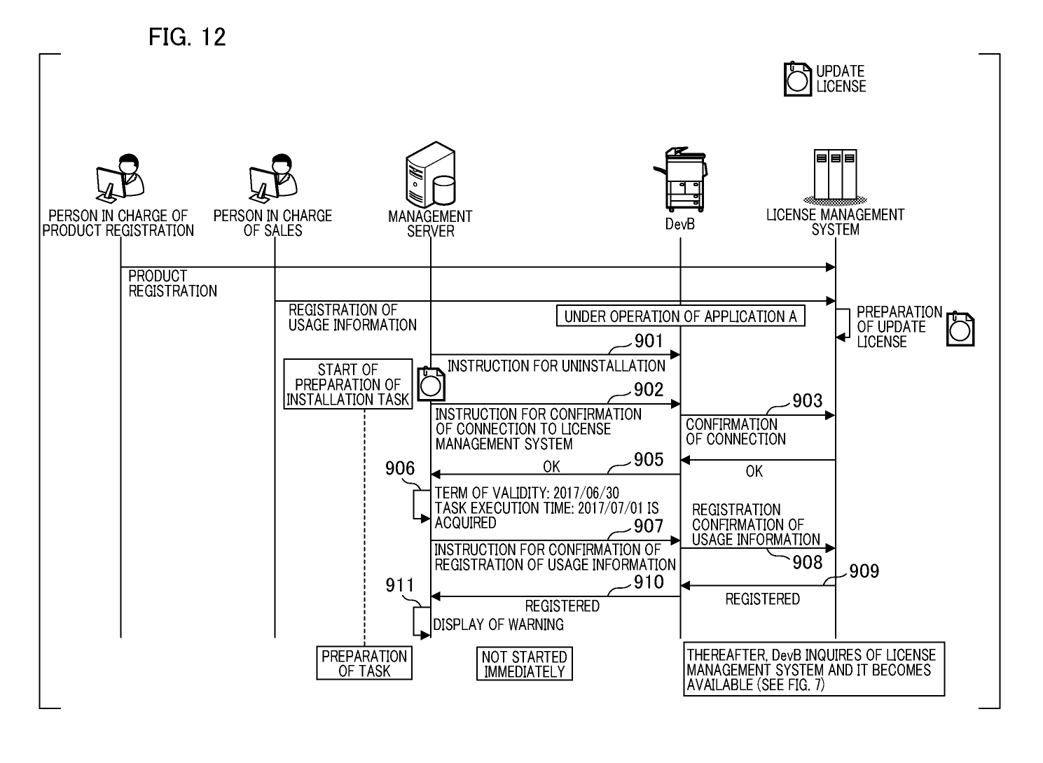

FIG. 12 is a diagram illustrating an example in which the management server 1000 prepares a task for installing a second application A in an image forming apparatus DevB. An application ID (Application-ID) of the application A is assumed to be AAA00012 similarly to FIG. 11. Details of a license selected in the prepared installation task (S803) are illustrated in FIG. 14A.

In FIG. 14A, details of the license for the image forming apparatus DevB are assumed to designate a license 102. Specifically, it is assumed that the license 102 has the same details as the license 101 except that a device (Serial-No) which is an object of the license 102 is ZZZ9998 (DevB).

FIG. 14B is a diagram illustrating usage information which is registered in the license management system 4000.

Data 106 and data 107 indicate usage information which is registered for DevB. Specifically, the data 106 and the data 107 are usage information on ZZZ9998 (DevB) which is a device serial number for uniquely identifying a device. The data 107 is usage information after the usage information of the data 106 has been updated.

The data 106 and the data 107 indicate that an application with an application ID of AAA0012 is enabled in the following term of validity. In the data 106, the term of validity is set to a period of 2017 Jun. 1 to 2017 Jun. 30. In the data 107, the updated term of validity is set to a period of 2017 Jul. 1 and 2017 Jul. 31.

In FIG. 12, product registration, registration of usage information, and uninstallation which are performed before an installation task is prepared are the same as illustrated in FIG. 11 and thus description thereof will not be repeated. In FIG. 12, it is assumed that the image forming apparatus DevB is connected to the license management system 4000 at a time point at which preparation of the installation task is started. An example in which the management server 1000 prepares a task for installing the second application A in the image forming apparatus DevB in this state will be described below.

In FIG. 12, when the installation task is prepared, installation of the second application is selected (S801), and an update license for the second application is selected as a license which is used for installation (S803). 2017/07/01 is set in a schedule for executing the installation task. At this time, it is determined that there is the second application and the update license for the second application (S805), and instruction for confirmation of connection (902) to the license management system 4000 is performed on the image forming apparatus DevB (S806).

When the instruction for confirmation of connection is received, the image forming apparatus DevB performs connection confirmation (903) to the license management system 4000. The image forming apparatus DevB is connected to the license management system 4000 and thus performs notification (905) of the management server 1000 about connection.

Then, the management server 1000 performs acquisition (906) of a contract end date indicated by the update license stored in the license data storage unit 39 and an execution time of the installation task. As indicated by the license 102 in FIG. 14A, the contract end date of the update license for the image forming apparatus DevB is set to 2017 Jun. 30, and the execution time of the task is set to 2017 Jul. 1.

Therefore, the management server 1000 determines that the update license which is used for installation when the installation task is executed is invalid (S810). The management server 1000 sends an instruction for confirmation (907) of whether usage information has been registered in the license management system 4000 to the image forming apparatus DevB (S811).

When the instruction for confirmation of registration of usage information is received, the image forming apparatus DevB performs registration confirmation (908) of usage information on the license management system 4000. The usage information of the image forming apparatus DevB is registered in the license management system 4000 as indicated by the data 107 in FIG. 14B.

That is, in addition to a period of 2017 Jun. 1 to 2017 Jun. 30, a period of 2017 Jul. 1 to 2017 Jul. 31 is also set as the updated term of validity. When the notification (909) indicating the setting is received from the license management system 4000, the image forming apparatus DevB performs notification (910) indicating that the usage information has been registered on the management server 1000. The management server 1000 performs display of a warning (911) in response to the notification (S817).

FIG. 15B illustrates an example of a warning which is displayed when the update license used for installation at the time of execution of the installation task is not valid but the usage information has been registered.

The warning indicates an image forming apparatus in which the license is not valid and thus in which usage of the application cannot be immediately started. Accordingly, the user can understand that the term of validity of the license has expired but usage of the application can be started after the license has been updated when the application is installed in the image forming apparatus DevB.

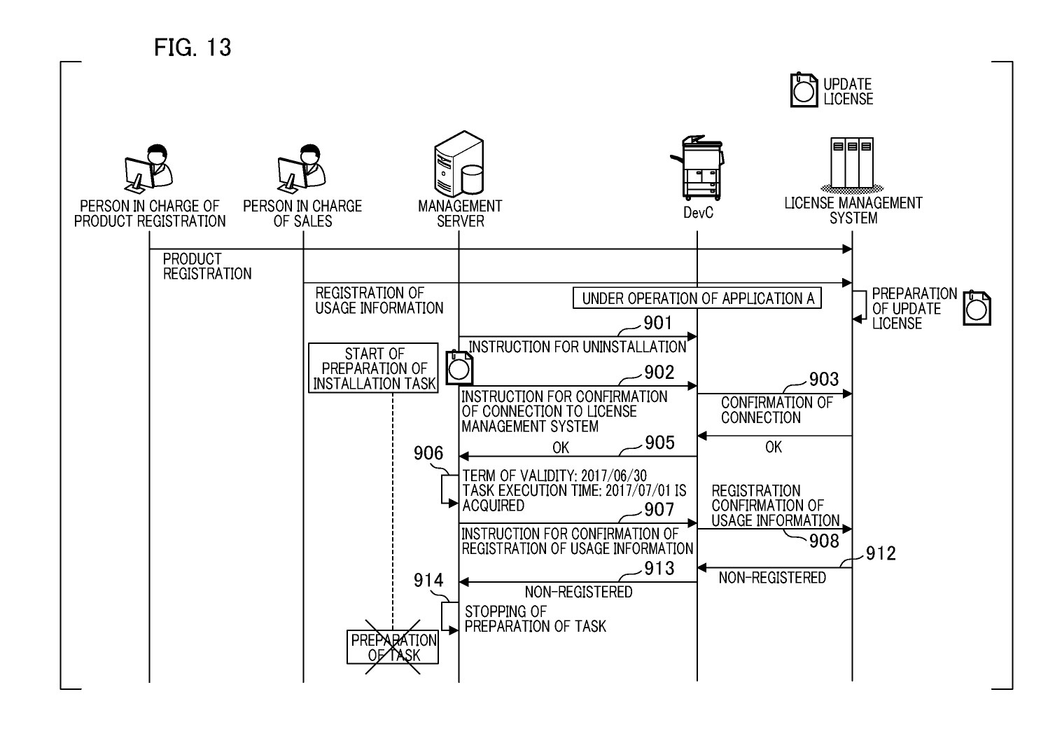

FIG. 13 is a diagram illustrating an example in which the management server 1000 prepares a task for installing a second application A in an image forming apparatus DevC. An application ID (Application-ID) of the application A is assumed to be AAA00012 similarly to FIG. 11. Details of a license selected in the prepared installation task (S803) are illustrated in FIG. 14A.

In FIG. 14A, details of the license for the image forming apparatus DevC are assumed to designate a license 103. Specifically, it is assumed that the license 103 has the same details as the license 101 except that a device (Serial-No) which is an object of the license 103 is ZZZ9997 (DevC).

FIG. 14B is a diagram illustrating usage information which is registered in the license management system 4000.

Data 108 indicates usage information which is registered for DevC. Specifically, the data 108 is usage information on ZZZ9997 (DevC) which is a device serial number for uniquely identifying a device. In the data 108, the term of validity for the application with an application ID of AAA0012 is set to a period of 2017 Jun. 1 to 2017 Jun. 30.

In FIG. 13, product registration, registration of usage information, and uninstallation which are performed before an installation task is prepared are the same as illustrated in FIG. 11 and thus description thereof will not be repeated. In FIG. 13, it is assumed that the image forming apparatus DevC is connected to the license management system 4000 at a time point at which preparation of the installation task is started. An example in which the management server 1000 prepares a task for installing the second application A in the image forming apparatus DevC in this state will be described below.

In FIG. 13, when the installation task is prepared, installation of the second application is selected (S801), and an update license for the second application is selected as a license which is used for installation (S803). 2017/07/01 is set in a schedule for executing the installation task.

At this time, it is determined that there is the second application and the update license for the second application (S805), and instruction for confirmation of connection (902) to the license management system 4000 is performed on the image forming apparatus DevC (S806). The processes from the instruction for confirmation of connection (902) to the registration confirmation of usage information (908) in the license management system 4000 by the image forming apparatus DevC are the same as illustrated in FIG. 12.

When the instruction for confirmation of registration of usage information is received, the image forming apparatus DevC performs registration confirmation of usage information (908) in the license management system 4000. The usage information of the image forming apparatus DevC is registered in the license management system 4000 as indicated by the data 108 in FIG. 14B. That is, a period from 2017 Jun. 1 to 2017 Jun. 30 is set as the term of validity.

When notification indicating such an intent (912) is received from the license management system 4000, the image forming apparatus DevC performs notification (912) indicating non-registration on the management server 1000. The management server 1000 receives the notification (913) indicating non-registration and performs stopping of preparation of an installation task (914) (S818). The management server 1000 displays stopping of preparation of the installation task.

FIG. 15C illustrates an example of a screen which is displayed when the update license used for installation at the time of execution of the installation task is not valid and the usage information has not been registered.

The screen displays an image forming apparatus in which a license is not valid and usage information has not been registered and thus also displays stopping of preparation of the installation task for the application.

### Second Embodiment

In the first embodiment, a case in which the term of validity of an update license used for installation of a second application has expired and the license is not valid and in which usage information has been registered after the term of validity has been updated is described above. In the first embodiment, in this case, usage of the second application cannot be immediately started until the update license is updated. On the other hand, in a second embodiment, in this case, a method of causing the management server 1000 to control delivery of an update license such that usage of the second application can be immediately started will be described.

The configuration of the device management system according to this embodiment and the hardware and software configurations of the devices are the same as those in the device management system according to the first embodiment. Therefore, the same elements as in the first embodiment will be referred to by the same reference signs and description thereof will be omitted.

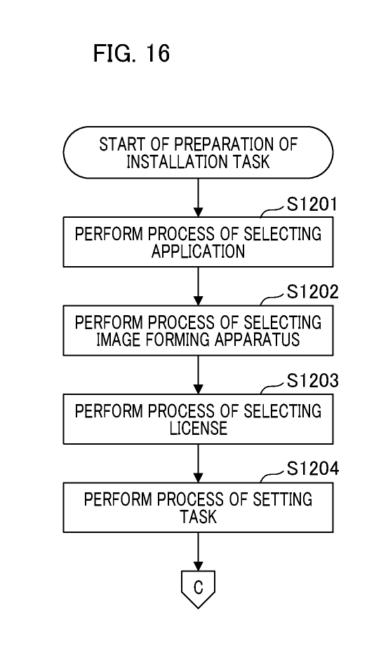

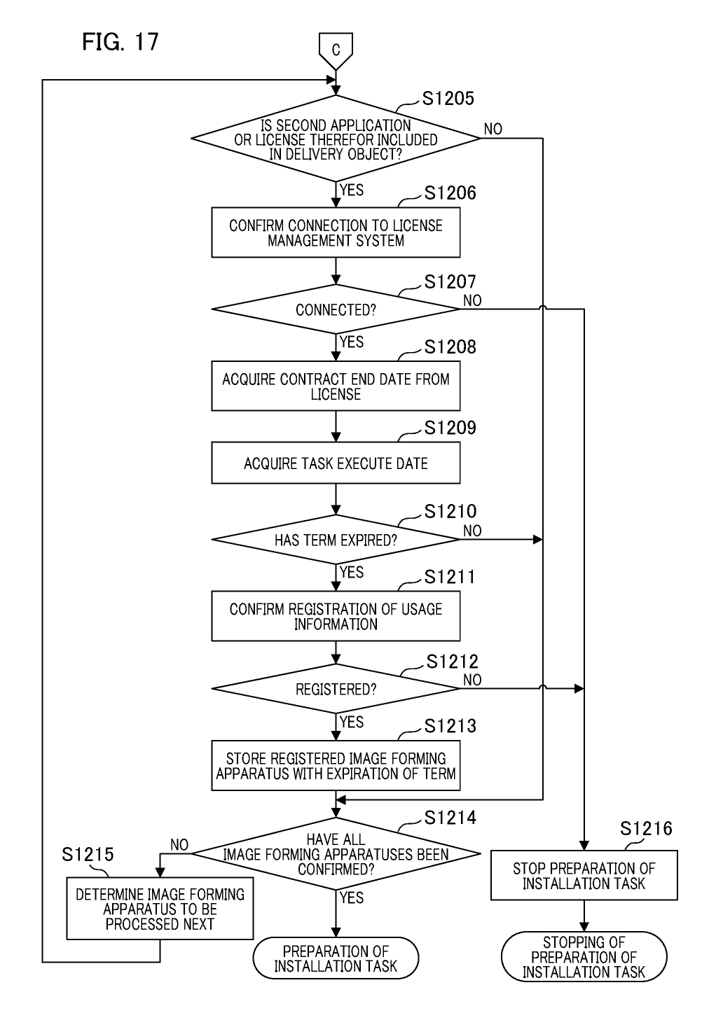

FIGS. 16 and 17 are flowcharts illustrating process routines of causing the management server 1000 to prepare a task (an installation task) for installing a second application in an image forming apparatus according to this embodiment.

The process routines illustrated in FIGS. 16 and 17 are realized by causing the CPU 10 to load and execute device management software in the RAM 12.

The process routine of preparing an installation task according to this embodiment illustrated in FIGS. 16 and 17 is different from the process routine of preparing an installation task according to the first embodiment illustrated in FIGS. 8 to 10 in application of information of an image forming apparatus stored in Step S1213 (S813). Due to this difference, in this embodiment, the processes of Steps S816 and S817 are not performed and display of a warning is not performed. Only the difference from the first embodiment will be described below.

In Step S1213, similarly to Step S813, the installation managing unit 36 stores information of an image forming apparatus in the RAM 12. That is, information of an image forming apparatus in which an update license used for installation at the time of execution of an installation task is not valid and usage information has been registered after the term of validity has been updated is stored in the RAM 12. The image forming apparatus of which the information is stored is an image forming apparatus in which usage of the application cannot be immediately started when the update license has not been updated when the installation task is executed.

That is, when the image forming apparatus has been restarted, at a specific time, or the like, usage of the installed application cannot be started until an inquiry about an update license is transmitted from the image forming apparatus to the license management system. Therefore, in this embodiment, the stored information is used for the management server 1000 to execute the installation task.

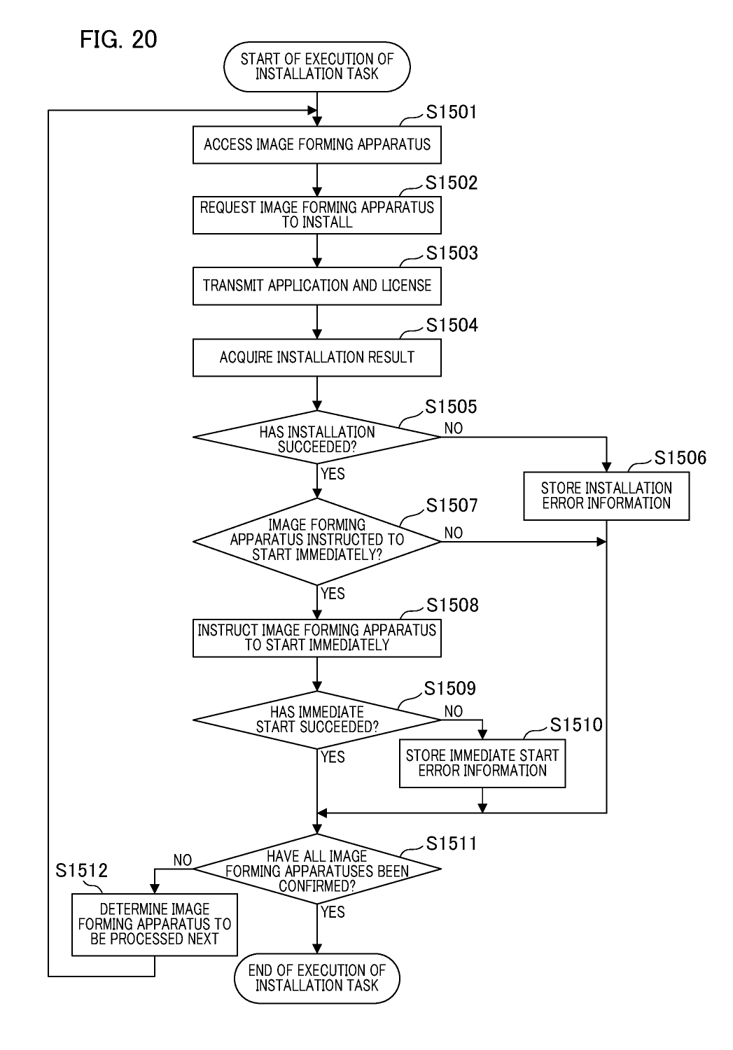

Specifically, when an application is installed in an image forming apparatus, the management server controls update of the update license such that usage of the application can be started without waiting for an inquiry about updating of the update license from the image forming apparatus. Detailed processes thereof will be described later with reference to FIG. 20.

In this embodiment, as described above, when an application is installed in an image forming apparatus, usage of the application can be started without waiting for an inquiry about update of the update license from the image forming apparatus and thus it is not necessary to display a warning. Accordingly, in this embodiment, the processes of Steps S816 and S817 are not performed.

FIG. 20 is a flowchart illustrating a process routine for causing the management server 1000 to execute an installation task for a second application.

Execution of the installation task is started by causing the task managing unit 33 of the management server 1000 to instruct the installation managing unit 36 to execute a task in accordance with a schedule (a delivery time) set in the task. The processes of Steps S1501 to S1511 are repeatedly performed on all the image forming apparatuses selected as an installation destination in Step S1202.

First, in Step S1501, the installation managing unit 36 acquires address information of an image forming apparatus which is a delivery destination of a second application included in the installation task from a device list stored in the device data storage unit 34. The installation managing unit 36 accesses the image forming apparatus as a delivery destination using the acquired address information. For example, an SOAP may be used as a communication protocol for the access, but the invention is not limited thereto.

In Step S1502, the installation managing unit 36 requests the accessed image forming apparatus to install the application. In Step S1503, the installation managing unit 36 acquires an application and a license file which are stored in the application data storage unit 38 and the license data storage unit 39, respectively.

The installation managing unit 36 transmits the acquired application and the acquired license to the image forming apparatus. As described above, regarding the installation task, an installation task of delivering only the license instead of delivering the license for the application along with the application can also be prepared.

In this case, the installation managing unit 36 does not acquire the application but acquires only the license file in Step S1503, and transmits the acquired license to the image forming apparatus. In the following description, a part described as “an application and a license” has simply to be replaced with “a license.” When the application and the license are received from the management server 1000, the image forming apparatus performs a process of installing the application and notifies the management server 1000 of the installation result.

In Step S1504, the installation managing unit 36 receives the installation result from the image forming apparatus and stores the result in the RAM 12. In Step S1505, the installation managing unit 36 determines whether installation of the application in the image forming apparatus has succeeded on the basis of the result stored in the RAM. The process routine transitions to Step S1507 when the installation has succeeded, and the process routine transitions to Step S1506 when the installation has failed.

In Step S1506, the installation managing unit 36 stores an error code associated with the failed installation in the RAM 12. The stored error code is correlated with detailed error information and can be referred to as an execution result of the installation task.

In Step S1507, the installation managing unit 36 determines whether information of an image forming apparatus in which usage of the application cannot be immediately started when the image forming apparatus has not updated the update license has been stored in Step S1213 at the time of preparation of the installation task. When information as an image forming apparatus in which usage of the application cannot be immediately started when the image forming apparatus does not update the update license has been stored, the process routine transitions to Step S1508. When information as an image forming apparatus in which usage of the application cannot be immediately started when the image forming apparatus does not update the update license has not been stored, the process routine transitions to Step S1511.

In Step S1508, the installation managing unit 36 instructs the image forming apparatus to update the update license. In other words, the installation managing unit 36 instructs the image forming apparatus to immediately start the application. When the instruction to update the update license is received, the application managing unit 43 of the image forming apparatus inquires of the license management system 4000 about the update license.

When usage information on a desired application has been registered in the image forming apparatus having transmitted the inquiry, the license management system 4000 returns the update license to the image forming apparatus. The application managing unit 43 of the image forming apparatus installs (applies) the received update license and starts usage of the application. The application managing unit 43 of the image forming apparatus notifies the management server 1000 of the update result of the update license.

In Step S1509, the installation managing unit 36 notified of the update result from the image forming apparatus and determines whether usage of the application in the image forming apparatus has been started, that is, whether the instruction to start the application has succeeded. The process routine transitions to Step S1511 when usage of the application in the image forming apparatus has been started, and the process routine transitions to Step 1510 when usage of the application has not been started.

In Step S1510, the installation managing unit 36 stores an error code associated with the failed update in the RAM 12. The stored error code is correlated with detailed error information and can be referred to as the execution result of the installation task.

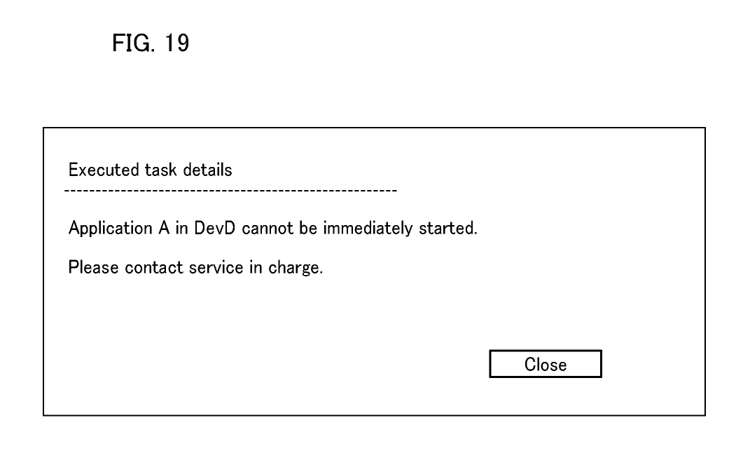

FIG. 19 illustrates an example of a screen which is displayed when an update license in an image forming apparatus has not been updated and usage of an application has not been started.

When an error code has been returned from an image forming apparatus due to a certain problem, details of the error can be ascertained from the information on the image forming apparatus stored in Step S1510.

Referring back to FIG. 20, the processes of Steps S1511 to S1512 are the same as the processes as Steps S814 to S815 and thus detailed description thereof will be omitted. When the process of installing an application is performed on all the image forming apparatuses selected in Step S1202 through the processes of Steps S1511 to S1512, the process routine for executing an installation task ends.

In this way, in this embodiment, when a term of validity indicated by an update license to be delivered has expired and usage information has been registered after the term of validity has been updated, usage of the second application can be immediately started.

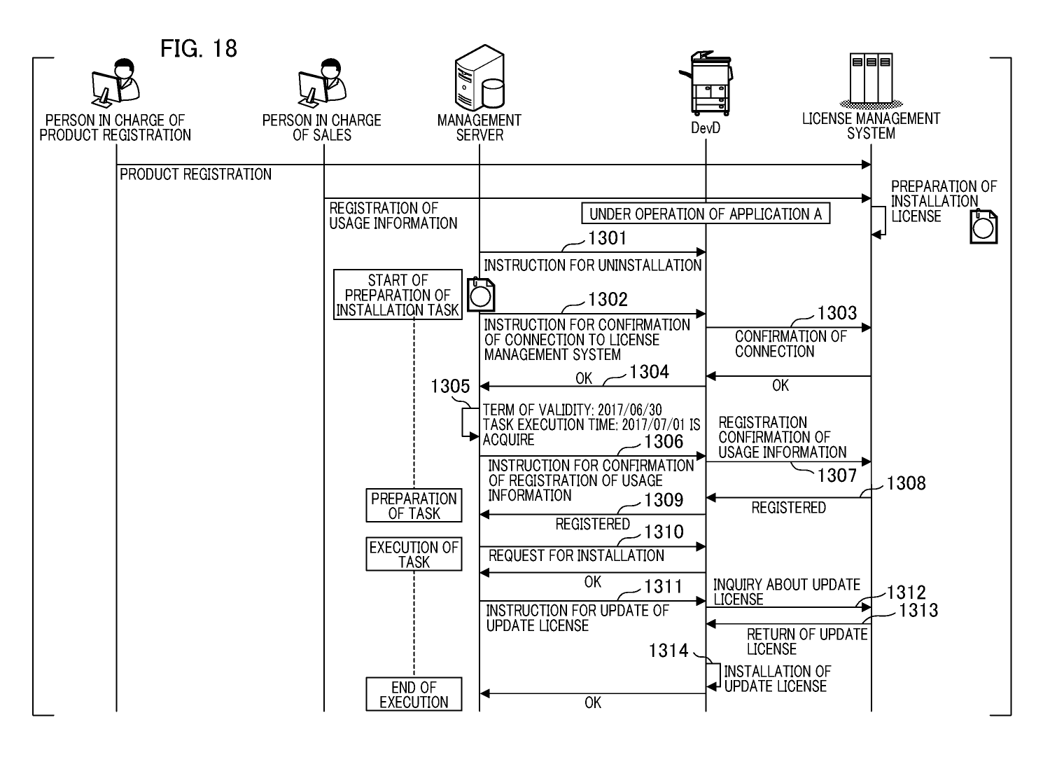

FIG. 18 is a diagram illustrating an example in which the management server 1000 prepares a task for installing a second application A in an image forming apparatus DevD and executes the task. An application ID (Application-ID) of the application A is assumed to be AAA00012 similarly to FIG. 12. Details of a license selected in the prepared installation task (S1203) are illustrated in FIG. 14A.

In FIG. 14A, details of the license for the image forming apparatus DevD are assumed to designate a license 104. Specifically, it is assumed that the license 104 has the same details as the licenses 101 to 103 except that a device (Serial-No) which is an object of the license 104 is ZZZ9996 (DevD).

FIG. 14B is a diagram illustrating usage information which is registered in the license management system 4000.

Data 109 and data 110 indicate usage information which is registered for DevD. Specifically, the data 109 and the data 110 are usage information on ZZZ9996 (DevD) which is a device serial number for uniquely identifying a device. The data 110 is usage information after the usage information of the data 109 has been updated.

The data 109 and the data 110 indicate that an application with an application ID of AAA0012 is enabled in the following terms of validity. In the data 109, the term of validity is set to a period of 2017 Jun. 1 to 2017 Jun. 30. In the data 110, the updated term of validity is set to a period of 2017 Jul. 1 and 2017 Jul. 31.

In FIG. 18, product registration, registration of usage information, and uninstallation (1301) which are performed before an installation task is prepared are the same as illustrated in FIG. 11 and thus description thereof will not be repeated. In FIG. 18, it is assumed that the image forming apparatus DevD is connected to the license management system 4000 at a time point at which preparation of the installation task is started.

An example in which the management server 1000 prepares a task for installing the second application A in the image forming apparatus DevD in this state and requests the image forming apparatus to install the second application A in accordance with the task will be described below.

In FIG. 18, when the installation task is prepared, installation of the second application is selected (S1201), and an update license for the second application is selected as a license which is used for installation (S1203). 2017/07/01 is set in a schedule for executing the installation task.

At this time, it is determined that there is the second application and the update license for the second application (S1205), and instruction for confirmation of connection (1302) to the license management system 4000 is performed on the image forming apparatus DevD (S1206). The processes from the instruction for confirmation of connection (1302) to notification (1309) indicating that the image forming apparatus DevD has been registered in the management server 1000 are the same as the processes of Steps 901 to 910 in FIG. 12.

The management server 1000 receives the notification and stores DevD as an image forming apparatus in which usage of the application cannot be immediately started without updating the update license when the installation task has been executed in the RAM 12 (S1213). Then, the management server 1000 ends the preparation of the installation task.

At the task execution time of 2017 Jul. 1, the management server 1000 executes the installation task. Specifically, in the management server 1000, the installation managing unit 36 receives an instruction from the task managing unit 33 and executes the installation task. First, the management server 1000 transmits a request for installing the application A (1310) to the image forming apparatus DevD (S1502).

When the request for installation is received, the image forming apparatus DevD installs the application and notifies the installation result. Here, it is assumed that installation of the application in the image forming apparatus DevD has succeeded. The management server 1000 determines that the image forming apparatus DevD is an image forming apparatus of which information is stored as an image forming apparatus in which usage of the application cannot be immediately started without updating the update license (S1507).

The image forming apparatus DevD is instructed to update the update license (1311). When an instruction to update the update license is received, the image forming apparatus DevD inquires of the license management system 4000 about the update license (1312).

Since usage information of the application A in the image forming apparatus DevD has been registered as indicated by the data 110 in FIG. 14B, the license management system 4000 returns the update license to the image forming apparatus DevD (1313). Details of the license for the image forming apparatus DevD which is returned at that time designate the license 105 in FIG. 14A.

The license 105 is different from the license 104 which is a license for the same image forming apparatus DevD in the values of Contract-Start-Date and Contract-End-Date. In the license 105, it can be understood that the term of validity based on the license is updated to a period of 2017 Jul. 1 to 2017 Jul. 31 to correspond to details of the registered usage information (the data 110).

The image forming apparatus DevD installs the received update license and starts usage of the application A (1314). The management server 1000 ends execution of the installation task in response to starting of the usage of the application A in the image forming apparatus DevD.

The invention may be applied to a system including a plurality of devices (for example, a host computer, an interface device, a reader, and a printer) or may be applied to a system (for example, a copier or a facsimile) including a single device.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-164716, filed Aug. 29, 2017, which is hereby incorporated by reference wherein in its entirety.

What is claimed is:

1. A management apparatus comprising:
a memory storing instructions; and
a processor executing the instructions causing the management apparatus to:
transmit an instruction causing an image forming apparatus to communicate with a license management system to the image forming apparatus when setting of delivery of an application and an update license for the application or the update license to the image forming apparatus is performed;
display a warning indicating that a license to be delivered to the image forming apparatus will not be updated when the image forming apparatus has failed to communicate with the license management system in accordance with the instruction; and
deliver the application and the update license or the update license on the basis of the setting of delivery when the image forming apparatus has succeeded in communicating with the license management system in accordance with the instruction.

2. The management apparatus according to claim 1, wherein a start time and an end time indicating a period in which the application is enabled and identification of an available image forming apparatus are set in the update license.

3. The management apparatus according to claim 1,
wherein the image forming apparatus in which the application has been installed using an installation license requests the license management system for an update license of the application to continuously use the application, and
wherein the instructions further cause the management apparatus to acquire the update license from the image forming apparatus.

4. The management apparatus according to claim 1, wherein a warning indicating that the license to be delivered to the image forming apparatus will not be updated is displayed when the license management system does not manage registration information of the image forming apparatus.

5. The management apparatus according to claim 1, wherein, in the displaying, a warning is displayed on the basis of a delivery time of the setting of delivery and a period in which the update license to be delivered is enabled.

6. The management apparatus according to claim 5, wherein, in the transmission, an instruction causing the image forming apparatus to update the license to be delivered is transmitted if the image forming apparatus has succeeded in communicating with the license management system in accordance with the instruction, and the delivery time of the setting of delivery has elapsed the period in which the update license to be delivered is enabled but the license management system manages registration information of the image forming apparatus.

7. The management apparatus according to claim 6, wherein, in the transmission, the instruction causing the image forming apparatus to update the license to be delivered is transmitted after the application and the update license or the update license has been delivered and the application has been installed.

8. A method for controlling a management apparatus, the method comprising:
transmitting an instruction causing an image forming apparatus to communicate with a license management system to the image forming apparatus when setting of delivery of an application and an update license for the application or the update license to the image forming apparatus is performed;
displaying a warning indicating that a license to be delivered to the image forming apparatus will not be updated when the image forming apparatus has failed to communicate with the license management system in accordance with the instruction; and
delivering the application and the update license or the update license on the basis of the setting of delivery when the image forming apparatus has succeeded in communicating with the license management system in accordance with the instruction.

9. A non-transitory storage medium on which is stored a computer program for making a computer execute:
transmitting an instruction causing an image forming apparatus to communicate with a license management system to the image forming apparatus when setting of delivery of an application and an update license for the application or the update license to the image forming apparatus is performed;
displaying a warning indicating that a license to be delivered to the image forming apparatus will not be updated when the image forming apparatus has failed to communicate with the license management system in accordance with the instruction; and
delivering the application and the update license or the update license on the basis of the setting of delivery when the image forming apparatus has succeeded in communicating with the license management system in accordance with the instruction.
